(19) United States
(12) Patent Application Publication
(10) Pub. No.: US 2008/0167873 A1
(43) Pub. Date: Jul. 10, 2008

(54) Orientation pronunciation

(76) Inventor: Wei-Chou Su, Tainan City (TW)

Correspondence Address: Wei-Chou Su, 235 Chung-Ho, Box 8-24, Taipei, omitted

(21) Appl. No.: 11/650,598

(22) Filed: Jan. 8, 2007

(51) Int. Cl. G10L 15/04

(52) U.S. Cl. 704/254; 704/260; 704/E15.008

(57) ABSTRACT

A method for pronunciation of English alphas according to the indications at different orientations of the alpha, comprises the steps of: dividing an area around an alpha into six sections, indicating short sounds, long sounds and strong sounds by points, lines and slashes; that put a small piece of line (in different angle) or point on an alpha indicating that it is pronounced by the pronunciation of another alpha; using underlines to indicate long sounds and short sounds of phonetic symbols of a set of double alphas; using a delete line to indicate that the alpha will not be pronounced, using a space area to divide syllables of a word; using a vertical cut line to indicate that one alpha is pronounced by two sounds; indicating an original sound line at an upper side of the first stroke to represents that the alpha is pronounced with an original sound; and a “←” under a double alpha set representing that the alpha is pronounced with a reverse sound.

### FIELD OF THE INVENTION

The present invention relates to phonetic symbols, and particularly to an orientation pronunciation method, which is helpful to the beginner to pronounce correctly. The points, lines (in different angle), slashes are used to indicate the pronunciations of words. The method of the present invention is suitable to be used in many kinds of language's books, dictionaries, and computers so that the beginner can know the pronunciation of the words correctly and easily.

### BACKGROUND OF THE INVENTION

In current used KK phonetic symbols, universal phonetic symbols, or natural pronunciations, etc., the alphas must be converted for pronunciation correctly. Not every alpha has a fixed pronunciation. Thus, a beginner will feel fuzzy and ca not accurately pronounces for any new vocabularies. Thus the beginner is worry about and dare not oration, read (talk, speak) English in public places. This made the beginner takes much times in learn English. This is because in conventionally pronunciation, many alphas must be converted into different phonetic symbols in pronunciation.

### SUMMARY OF THE INVENTION

Accordingly, the primary object of the present invention is to provide a method for pronunciation of English alphas according to the indications at different orientations of the alpha. Thus a reader can pronounce correctly with an easy way.

To achieve above objects, the present invention provides a method for pronunciation of English alphas according to the indications at different orientations of the alpha, comprising the steps of: dividing an area around an alpha into six sections, the same orientation having the same pronunciation; indicating long sounds, short sounds, strong (hard) sounds, original English alphas' sounds and [ [symbol] ] sounds by points, lines (in different angle) and slashes; using underlines to indicate long sounds and short sounds of phonetic symbols of a set of double alphas; using a delete line to represent that the alpha will not be pronounced, wherein an “e” at the end of a word is not deleted; using a space area to divide syllables of a word; using a vertical cut line to indicate that one alpha is pronounced by two sounds; indicating an original English alphas' sound line at an upper side of the first stroke of an alpha which represents that the alpha is pronounced with the original sound; and an “←” under a double alpha set representing that the alpha is pronounced with a reverse order sound (the second one alpha's sound change to the first one).

The various objects and advantages of the present invention will be more readily understood from the following detailed description when read in conjunction with the appended drawing.

### BRIEF DESCRIPTION OF THE DRAWINGS

FIG. 1 shows the orientation pronunciation of a vowel word according to the present invention.

FIG. 2 shows the orientation pronunciation for five vowel words according to the present invention.

FIG. 3 shows the orientation phonetic symbols of the present invention, where points, lines and slashes are indicated around an alpha.

FIG. 4 shows the orientation phonetic symbols of the present invention, that a small piece of line (in different angle) puts on alpha indicating that the pronunciation of alpha is changed to a new one which is like the original pronunciation of the alpha.

FIG. 5 is a phonetic symbol drawing an underline (long or short) to indicate long sounds or short sounds of phonetic symbols of a set of double alphas, showing that a bottom line is indicated at a lower side of a set of double alphas according to the present invention.

FIG. 6 is a phonetic symbol using a delete line to represent that the alpha will not be pronounced. The diagram showing that a delete line is indicated on a vowel word according to the present invention.

FIG. 7 is a schematic view showing that a space is used to represent a syllable of a word according to the present invention.

FIG. 8 is a phonetic symbol drawing showing that a cut line is indicated at a middle portion of a word.

FIG. 9 is a phonetic symbol showing that an upper side of the first stroke of an alpha is indicated with an original sound line according to the present invention.

FIG. 10 is a phonetic symbol drawing showing that a reverse arrow is indicated a lower side of a set of double alphas.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

In the present invention, the orientation pronunciation method can indicate the sound of a word easily and simply. The orientation pronunciation method of the present invention use the features for indication a map's orientation. The upper side is north; left side is west, etc. The six orientations of a vowel word and one consonant word, such as upper side, lower side, left lower side, right side, right lower side, right upper side, and middle side are indicated with a point (a short sound), a line (a long sound), a slash (a strong sound), etc. for indication the sound of a vowel word. A delete line on the alpha represents silence sound and a cut line represents dual sound so as to indicate the sound of a vowel word. Those having different orientations have different sounds. They are indicated by different phonetic symbols based on the orientations thereof so that the reader can read the sound easily.

The method about the orientation pronunciation of the present invention will be described hereinafter.

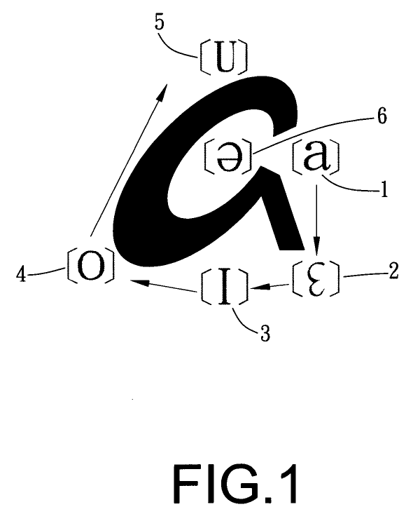

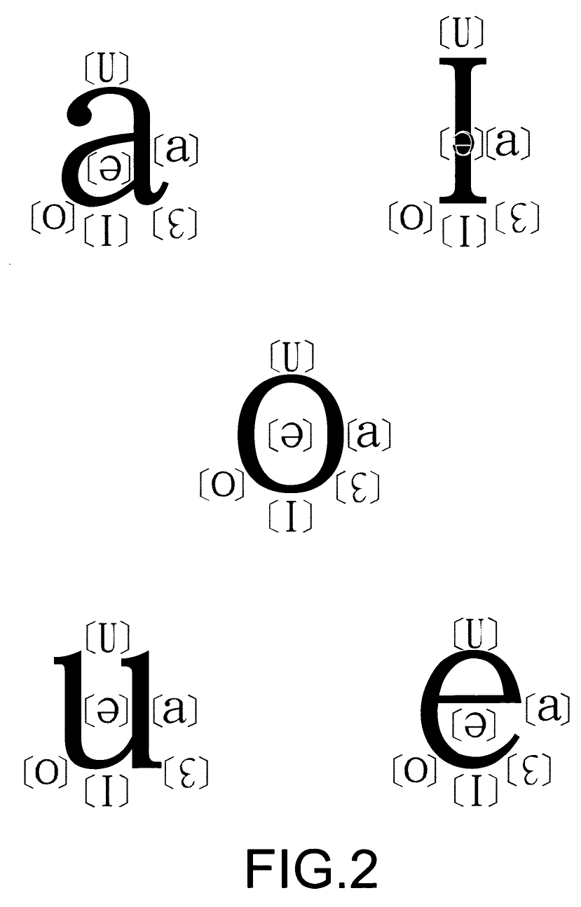

1. Each vowel is divided into six sections, which are [ [symbol] ], [ [symbol] ], [1], [ [symbol] ], [ [symbol] ], [ [symbol] ] (FIG. 1). The first orientation is ( [symbol] ), the second orientation is [symbol] , the second orientation is ( [symbol] ), the fourth orientation is ( [symbol] ), the fifth orientation is ( [symbol] ), and the sixth orientation is ( [symbol] ). Referring to FIG. 2, the same orientation has the same pronunciation.

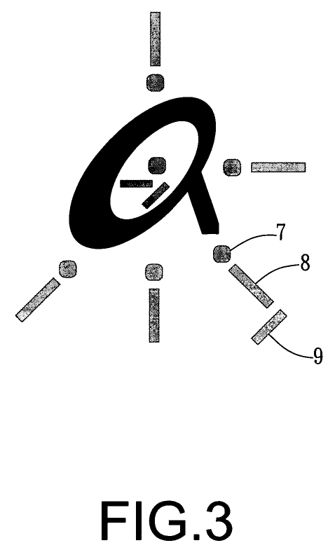

2. A point 7 represents a short sound, a line 8 represents a long sound and a slash 9 represents a strong sound (FIG. 3).

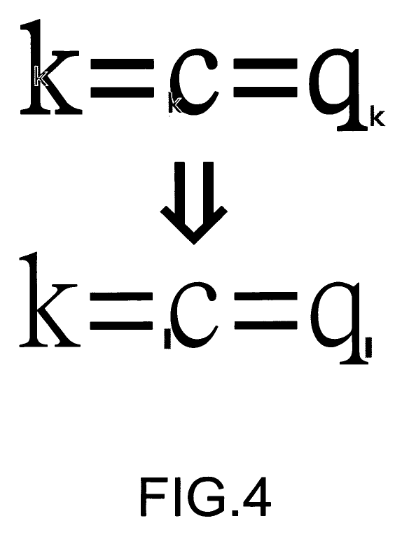

3. A points or a small piece of line (in different angle) on alpha represents that it is pronounced with the pronunciation of another alpha. (FIG. 4)

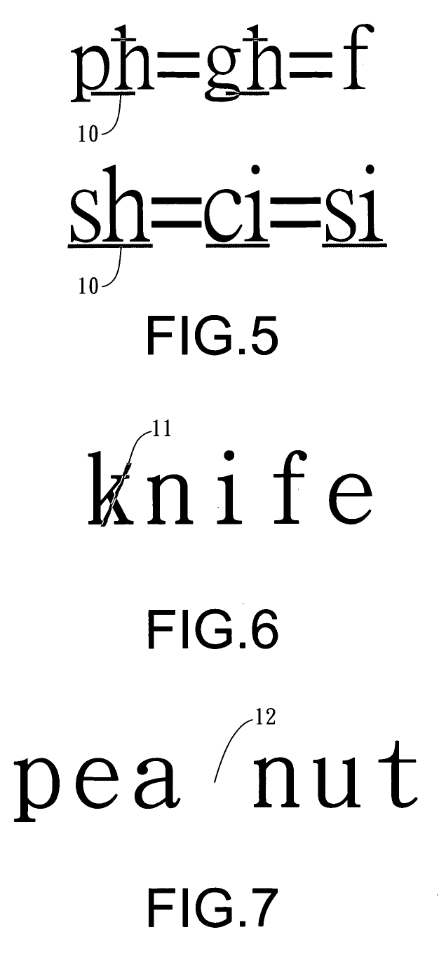

4. The long (sh) sound and short (ph) sound of a phonetic symbol with a set of double alphas are indicated with underlines 10 (FIG. 5).

5. A delete line 11 represents that the alpha will not be pronounced (FIG. 6) and the “e” at the end of a word is not deleted.

6. A space area 12 is used to divide the syllables of a word (FIG. 7).

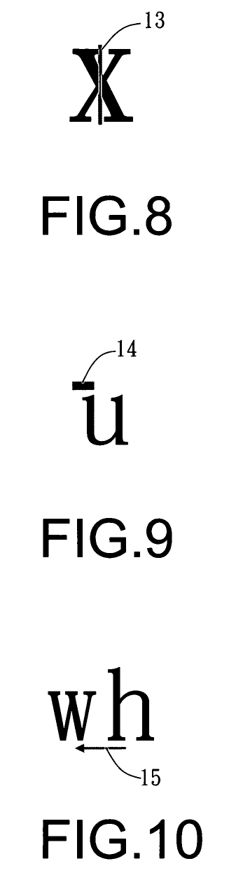

7. A vertical cut line 13 is used to indicate that one alpha has two sounds (FIG. 8).

8. An upper side of the first stroke of an alpha is indicated with an original sound line 14 which represents that the alpha is pronounced two sound [ [symbol] ] and [ [symbol] ], because they go fast, so made it like one a sound with a phonetic symbol identical as the alpha (FIG. 9).

9. A “←” (inverse arrow) indication under a double alphas set represents those two alphas is pronounced with the pronunciation of the second alpha being emitted firstly and the first alpha being pronounced secondly (FIG. 10).

About mentioned indication method is used to indication the pronunciation of the English alphas (From a to z) by the following way:

The aspect pronunciation of points, lines, and slashes for the alphas a to z.

(1) Seven pronunciations for the alpha A and a.

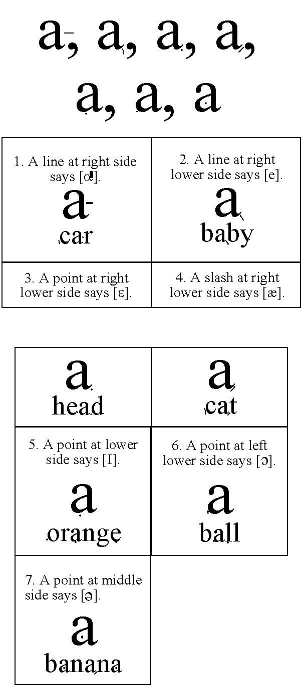

(2) The pronunciation [b] for the alphas B and b.

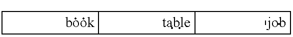

(3) Four pronunciations for the alphas C and c.

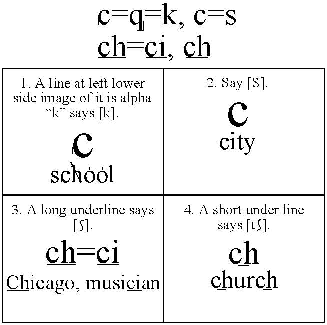

(4) Three pronunciations for the alphas D and d.

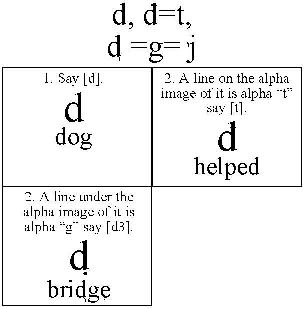

(5) Ten pronunciations for the alphas E

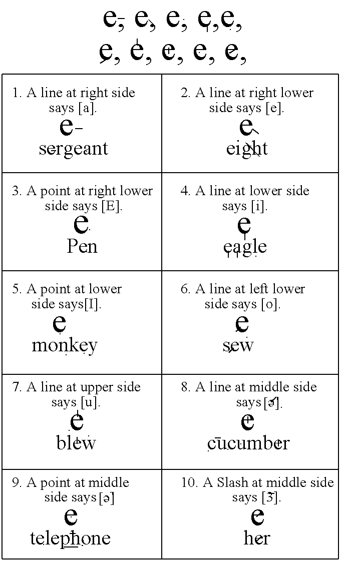

(6) The pronunciation [f] for the alpha F.

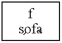

(7) Three pronunciations for the alphas G.

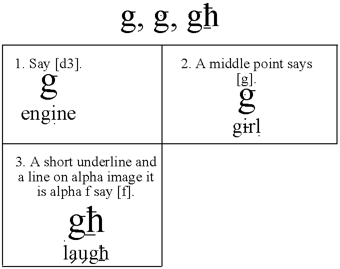

(8) Seven pronunciations for the alphas H.

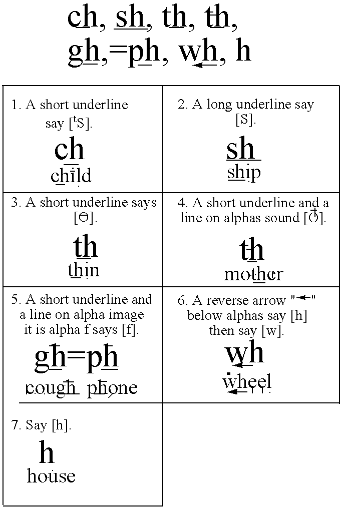

(9) Seven pronunciations for the alphas I.

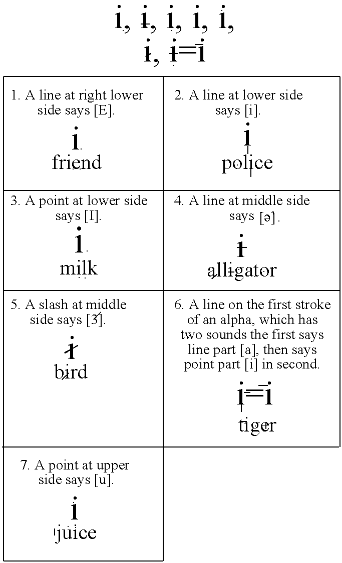

(10) The pronunciation [d3] for the alphas J. A line put on left side the alpha “j”, image of it is alpha “g” say [d3].

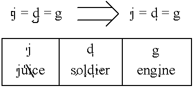

(11) The pronunciation [k] for the alphas K. A line put on left side the alpha “c”, image of it is alpha “k” say [k].

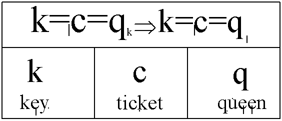

(12) Two pronunciations for the alphas L.

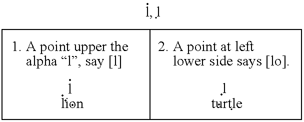

(13) The pronunciation “m” for the alphas M.

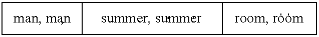

(14) Two pronunciations for the alphas N.

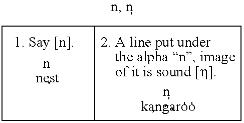

(15) Nine pronunciations for the alphas O and o

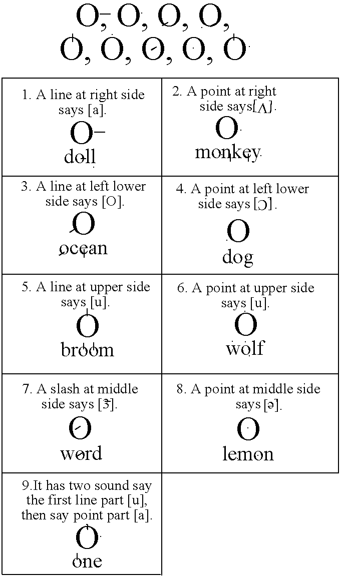

(16) Two pronunciations for the alphas P.

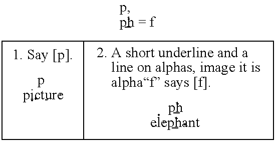

(17) The pronunciation [k] for the alphas Q. A line put on right side the alpha “q”, image of it is alpha “k” says [k].

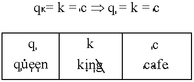

(18) The pronunciation [r] for the alpha R.

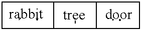

(19) Three pronunciations for the alphas S.

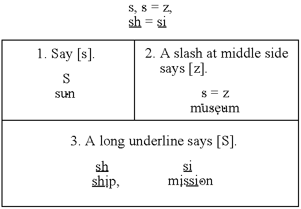

(20) Five pronunciations for the alphas T and t.

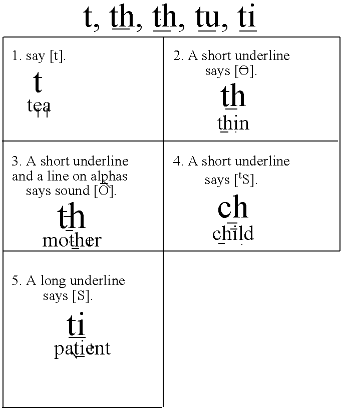

(21) Nine pronunciations for the alphas U.

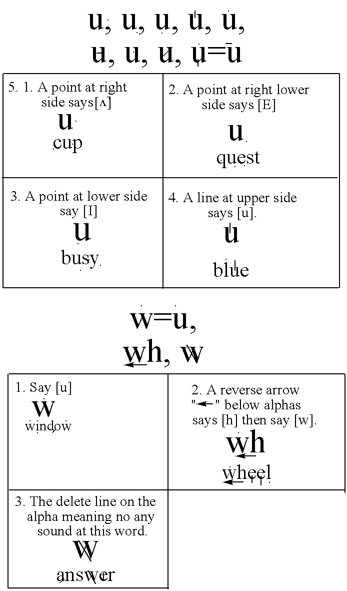

(24) Three pronunciations for the alphas X.

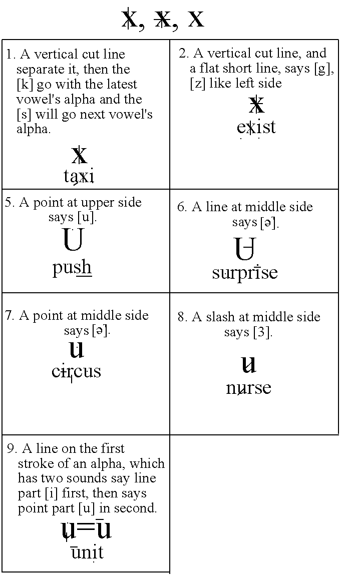

(22) The pronunciation [v] for the alphas V.

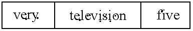

(23) The pronunciations of W and the delete line.

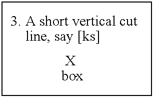

(25) Four pronunciations for the alphas Y.

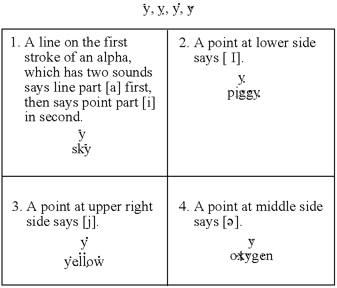

(26) The pronunciation [z] for the alphas Z.

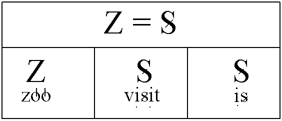

### EXAMPLE 1

Orientation pronunciation method are used to indicate the pronunciations of alphas a to z. A table for “The Orientation Pronunciation” are listed in the following.

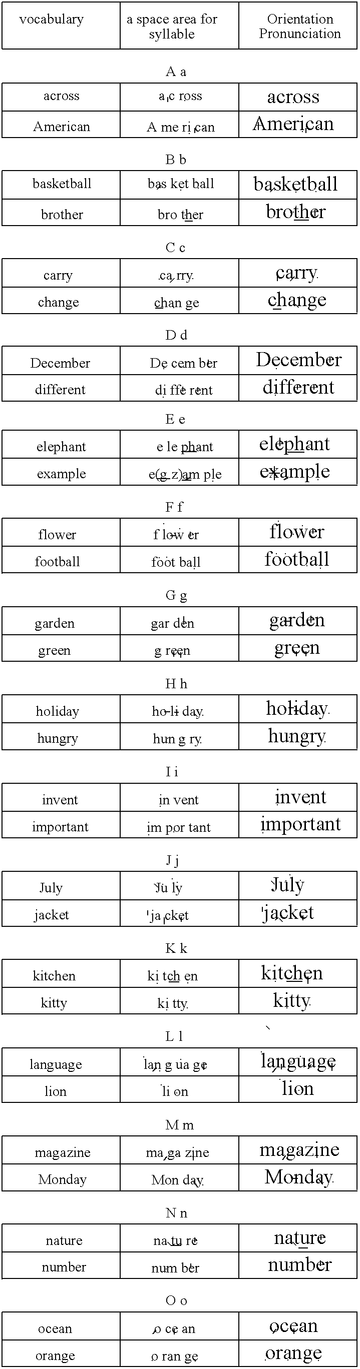

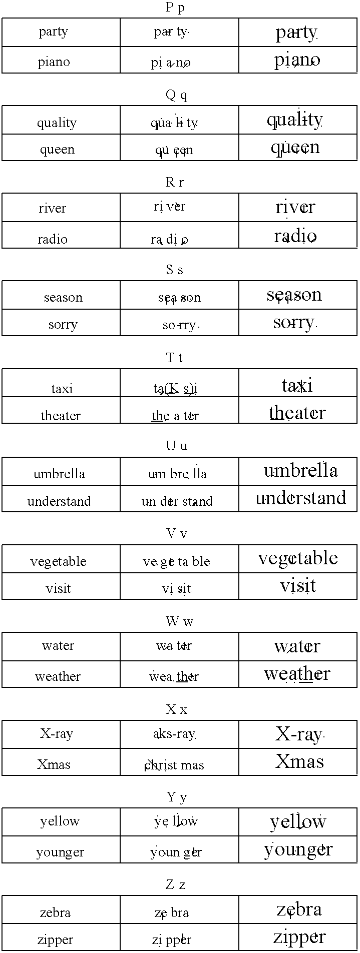

### EXAMPLE 2

The orientation phonetic symbols of the present invention are used to indicate the words in an article as the following paragraph.

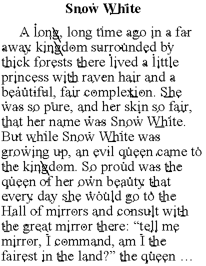

Advantages of the present invention will be described herein.

1. The orientation pronunciation method of the present invention can be used to indicate the pronunciations of words on the notebooks or dictionary for the beginners so that a beginner can learn the pronunciation of English easily and correctly.

2. The method of the present invention is easy to be learned by adults or teachers in a very short time.

3. The user can learn the method of the present invention by himself (herself) through the notebooks or dictionaries indicated with the orientation pronunciations according to the present invention.

4. The orientation pronunciation of the present invention can be used to indicate the pronunciations of words in various papers, journals, web pages, storybooks, etc in many kinds of languages. so that the users can pronounce the words correctly and easily.

The present invention is thus described; it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for pronunciation of English alphas according to indications at different orientations of the alpha, comprising the steps of:
dividing an area around an alpha into six sections, the same orientation having the same pronunciation;
indicating long sounds, short sounds and strong sounds by points, lines and slashes;
indicating a small piece of line (in different angle) or point on alpha to imaged that the new one original English alphas' sounds;
using underlines to indicate long sounds and short sounds of phonetic symbols of a set of double alphas;
using a delete line to represent that the alpha will not be pronounced, wherein an “e” at the end of a word is not deleted;
using a space area to divide syllables of a word;
using a vertical cut line to indicate that one alpha is pronounced by two sounds;
indicating a line at an upper side of the first stroke of an alpha which has two sound (the pronunciation indicated by the line is pronounced firstly and that of the point is pronounced secondly), but these sounds are emitted very quickly asonly one sound is emitted; and
an “←” under a double alpha set representing that the alpha is pronounced with a reverse sound.

2. The method of claim 1, wherein the first orientation is indicated as ( [symbol] ), the second orientation is indicated as ( [symbol] ), the second orientation is indicated as ( [symbol] ), the fourth orientation is indicated as ( [symbol] ), the fifth orientation is indicated as ( [symbol] ), and the sixth orientation is indicated as ( [symbol] ).

3. The method of claim 1, wherein a point represents a short sound, a line represents a long sound and a slash represents a strong sound.
